(19) United States
(12) Patent Application Publication
(10) Pub. No.: US 2010/0225659 A1
(43) Pub. Date: Sep. 9, 2010

(54) DISPLAY CONTROL DEVICE, DISPLAY CONTROL PROGRAM AND METHOD

(75) Inventor: Toshiya MIYAZAKI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/781,945

(22) Filed: May 18, 2010

Related U.S. Application Data
(63) Continuation of application No. PCT/JP2007/074204, filed on Dec. 17, 2007.

(51) Int. Cl. G06F 12/00

(52) U.S. Cl. 345/564

(57) ABSTRACT

A display control device includes a memory that stores display data to be displayed on a display section, an operation section that specifies a display area of the display section where the display data is displayed, an address setting section that sets a setting address value with respect to a memory address of the display data stored in the memory, an address specifying section that specifies a read start address value of the display area with respect to the memory address based on a first operation amount of the operation section, and a specified address changing section that changes, when the read start address value is equal to the setting address value, the read start address value to a different address value.

### CROSS-REFERENCE TO RELATED APPLICATIONS

This application is a continuation application, filed under 35 U.S.C. §111(a), of PCT Application No. PCT/JP2007/074204, filed Dec. 17, 2007, the disclosure of which is herein incorporated in its entirety by reference.

### FIELD

The present invention relates to a display control device, a display control program and a method that control displaying of display data.

### BACKGROUND

In recent years, it has become easier to access the Internet through cellular phones. Web pages that are once created for personal computers are more often viewed on cellular phones. However, many Web pages are created on the assumption that the Web pages will be viewed on the displays of personal computers. For example, the width of one Web page is about 1024 dots.

The latest cellular phones are equipped with displays that have a resolution of VGA (Video Graphics Array) or QVGA (Quad Video Graphics Array). The following techniques have been known in order to enable the above Web pages to be viewed on a smaller display than the personal computers: a technique of allowing part of a Web page to be viewed while leaving the configuration of the Web page unchanged; a technique of reducing a Web page in size before displaying the Web page; and a technique of changing the layout of a Web page so that the Web page fits into the display of a cellular phone. An operator of a Web site may create contents or Web pages for cellular phones so that the contents or Web pages are displayed in a suitable manner for the display size of the cellular phones.

The above Web page display method is realized by a configuration illustrated in FIG. 12. FIG. 12 is a diagram illustrating the configuration of a conventional cellular phone.

The conventional cellular phone 90 includes a communication section 901, a memory 902, a VRAM (Video RAM) 903, a graphic controller 904, an LCD (Liquid Crystal Display) 905, an operation section 906, an OS (Operating System) 910, a TCP/IP stack 911, and a browser 912.

The communication section 901 transmits and receives packet data. The memory 902 temporarily stores data. The VRAM 903 temporarily stores image information that is to be displayed as video images. The graphic controller 904 performs a process pertaining to displaying images. The LCD 905 displays information of the cellular phone 90. The operation section 906, such as a cursor key or track ball, is operated by a user to input information. The OS 910 takes control of the cellular phone 90. The TCP/IP stack 911 removes packet headers, which are information added to packet data received by the communication section 901, from the packet data before transmitting the packet data to the memory 902. The browser 912 performs rendering of Web pages written in HTML.

The following describes a process in which the conventional cellular phone 90 having the configuration illustrated in FIG. 12 displays a Web page. First the communication section 901 receives the packet data of a Web page. The TCP/IP stack 911 acquires the packet data from the communication section 901, removes a packet header from the packet data, and stores in the memory 902 the packet data from which the packet header has been removed. The browser 912 reads the packet data out from the memory 902, interprets the HTML, determines layout and objects, and then issues a Web page drawing command to the OS 910 so that the Web page is drawn on the LCD 905. After receiving the drawing command, the OS 910 activates the graphic controller 904 which then displays the above Web page on the LCD 905 as bitmap data.

When a user operates the operation section 906 after the Web page is displayed, the input information, i.e. information about an input direction of a cursor key or about how much the cursor key is operated, is transmitted to the browser 912 which then scrolls the Web page displayed on the LCD 905 or changes the display area depending on how much the cursor key is operated.

A known conventional technique related to the present invention is an image processing device, an image processing method, a medium, an outline extraction device and an outline extraction method that makes three-dimensional editing and the like easy for two-dimensional images (see Patent Document 1, for example).
[Patent Document 1] Japanese Laid-open Patent Publication No. 2000-57378

### DISCLOSURE OF THE INVENTION

### Objects of the Invention

However, there are problems with the conventional Web browsing technique of the above configuration. When a Web page is partially displayed by the partial browsing technique with the configuration of the Web page left unchanged, an area where the Web page is displayed on the LCD 905 of the cellular phone 90 is smaller than an area where the Web page is displayed on the display of a personal computer. Therefore, the problem is that it is more difficult to operate to view Web pages on the cellular phone than on the personal computer. As for the technique of reducing a Web page in size before displaying the Web page, there is another problem that the Web page could be so small that fonts and images are illegible. As for the technique of changing the layout of a Web page so that the Web page fits into the display of a cellular phone, there is the problem that since the layout of the Web page created to be viewed on personal computers is changed, the layout may significantly break down.

As for the Web pages created for cellular phones by a Web site operator, there is a limit on the total amount of contents and the number of characters per page due to a limited communication speed and processing capability of the cellular phones. Therefore, the amount of information is significantly different from a typical Web page.

### SUMMARY

According to an aspect of the invention, there is provided a display control device includes a memory that stores display data to be displayed on a display section, an operation section that specifies a display area of the display section where the display data is displayed, an address setting section that sets a setting address value with respect to a memory address of the display data stored in the memory, an address specifying section that specifies a read start address value of the display area with respect to the memory address based on a first operation amount of the operation section, and a specified address changing section that changes, when the read start address value is equal to the setting address value, the read start address value to a different address value, wherein the display area of the display data is displayed in an orthogonal coordinate system and the setting address value corresponds to a predetermined coordinate value on one axis in the display area of the display data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a display screen of a Web page according to an embodiment of the present invention.

FIG. 2 is a diagram illustrating a method of controlling the display screen according to an embodiment of the present invention.

FIG. 3 is a functional block diagram illustrating the configuration of a cellular phone according to an embodiment of the present invention.

FIG. 4 is a flowchart illustrating the operation of the cellular phone according to an embodiment of the present invention.

FIG. 5 is a flowchart illustrating the operation of a bitmap data coordinate conversion process that is based on a key operation amount.

FIG. 6 is a diagram illustrating bitmap data stored in a memory.

FIG. 7 is a graph illustrating a correlation between operation amount of a direction key and read start address.

FIG. 8 is a diagram illustrating a relationship between a given pixel point on bitmap data and a given pixel point whose coordinates have been converted.

FIG. 9 is a diagram illustrating a distance between a display area and a cylinder.

FIG. 10 is a diagram illustrating the cylinder and a radius thereof.

FIG. 11 is a graph illustrating a correlation between the radius of the cylinder and a key push retainment time.

FIG. 12 is a diagram illustrating the configuration of a conventional cellular phone.

### DESCRIPTION OF EMBODIMENT

Hereinafter, an embodiment of the present invention will be described with reference to the accompanying drawings.

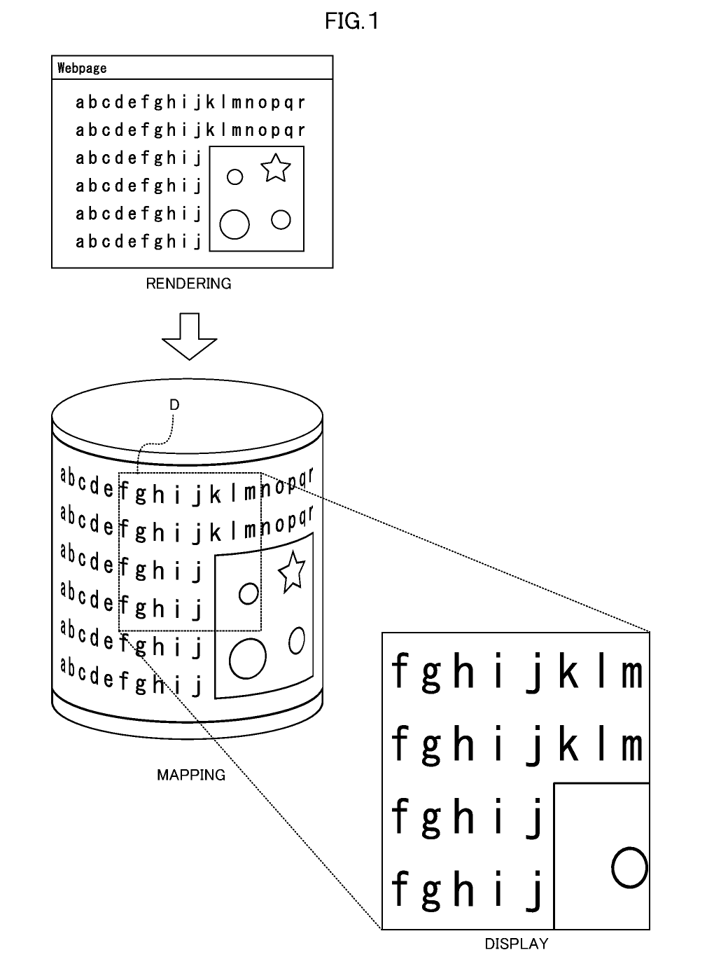

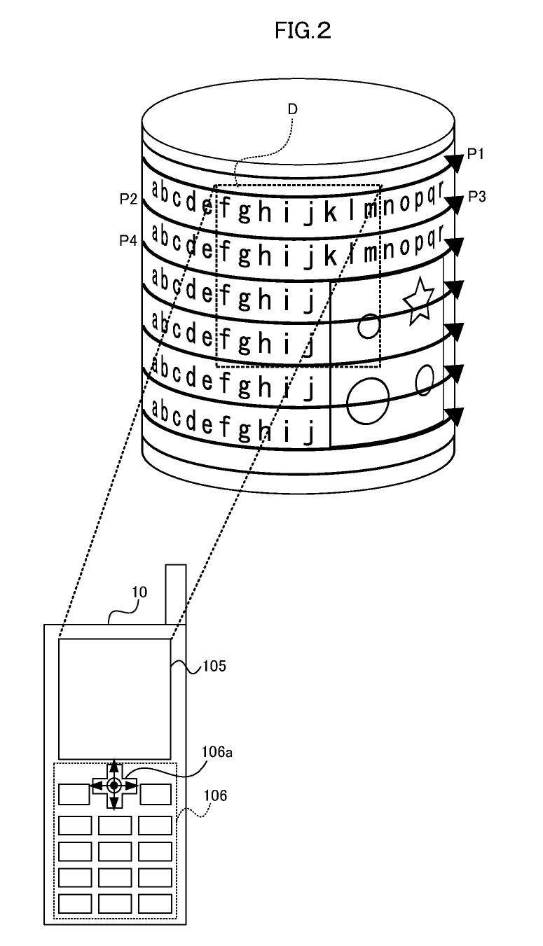

A brief overview of the present embodiment will be described with reference to FIGS. 1 and 2. FIG. 1 is a diagram illustrating a display screen of a Web page according to the present embodiment. FIG. 2 is a diagram illustrating a method of controlling the display screen according to the present embodiment.

As illustrated in FIG. 1, a rendered Web page is mapped on the side face of a cylinder. A portion indicated by a display area D is displayed on an LCD of a cellular phone described below.

As illustrated in FIG. 2, a cellular phone 10 (display control device) of the present embodiment includes an operation section 106 having a direction key 106a. The direction key 106a may be pressed at a center thereof and in four directions, i.e. an upward, downward, left or right direction. An LCD 105 (display section) displays a screen within the display area D.

According to the present embodiment, as the direction key 106a is pressed in a given direction with respect to the display area D, the cylinder moves or rotates in the opposite direction, i.e. the cylinder moves in the upward or downward direction or rotates in the left or right direction, thereby causing the display area to move. When a predetermined position P1 set on a horizontal axis of the Web page mapped onto the cylinder reaches the right end of the display area D after the direction key 106a is continuously pressed in the right direction, the display area D moves to a position where the left end of the display area D is superimposed on a predetermined position P2 which is different from at least P1 of the Web page on a vertical axis. The display area D similarly moves from P3 to P4. Therefore, a user of the cellular phone 10 just presses the direction key 106a in the right direction, and the display area D moves first in the right direction and then in the downward direction. Thanks to the movement of the display area D, the user may read texts and the like on the Web page without complicated operations. The opposite of the above operation is as follows: when the left end of the display area D reaches the end of the Web page after the direction key 106a is pressed in the left direction, the display area D moves a predetermined distance in the upward direction. The predetermined distance the display area D moves in the upward or downward direction may be automatically set according to the size of a font on the Web page or may be arbitrarily set by a user.

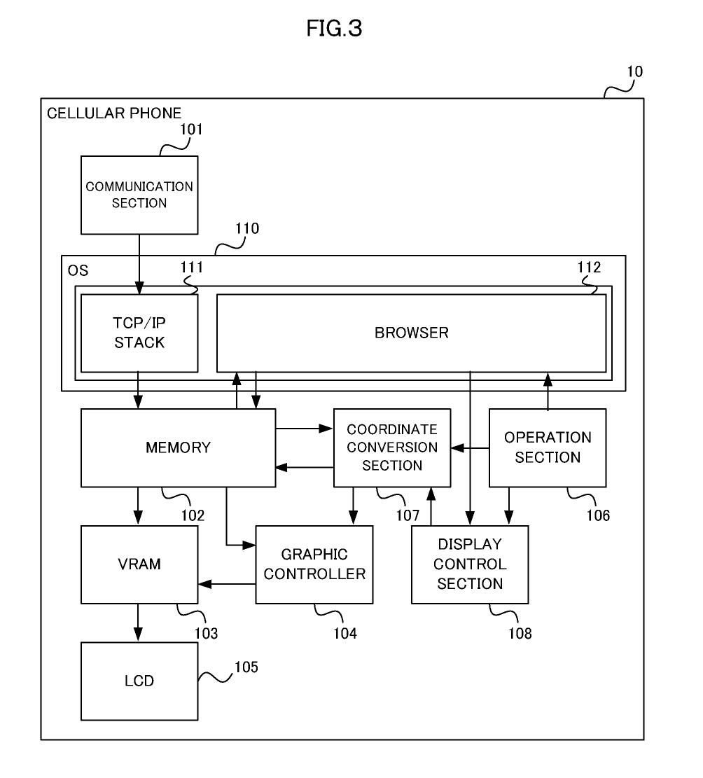

The following describes the configuration of the cellular phone 10 of the present embodiment with reference to FIG. 3. FIG. 3 is a block diagram illustrating the configuration of the cellular phone 10 according to the present embodiment.

The cellular phone 10 includes a communication section 101, a memory 102, a VRAM 103, a graphic controller 104, an LCD 105, the operation section 106, a coordinate conversion section 107, a display control section 108 (an address value setting section, an address specifying section, and a specified address changing section), an OS 110, a TCP/IP stack 111, and a browser 112.

The communication section 101 connects to a network and transmits and receives data. The memory 102 is a RAM and temporarily stores data that is to be processed in the cellular phone 10. The LCD 105 displays screens. The VRAM 103 acts as a buffer to buffer screen data that is to be displayed on the LCD 105. The graphic controller 104 is a processor that takes overall control of an image output process in the cellular phone 10. The operation section 106 includes the direction key 106a as described above as well as a plurality of other buttons.

The OS 110 controls the cellular phone 10. The TCP/IP stack 111 processes IP packets when data are transmitted or received through the communication section 101. The browser 112 performs rendering of HTML files (display data, or HTML data) written in HTML.

The coordinate conversion section 107 maps bitmap data of Web pages rendered by the browser 112 onto the side face of the cylinder. The display control section 108 determines a read start address for a display area described below on the basis of input from the operation section 106.

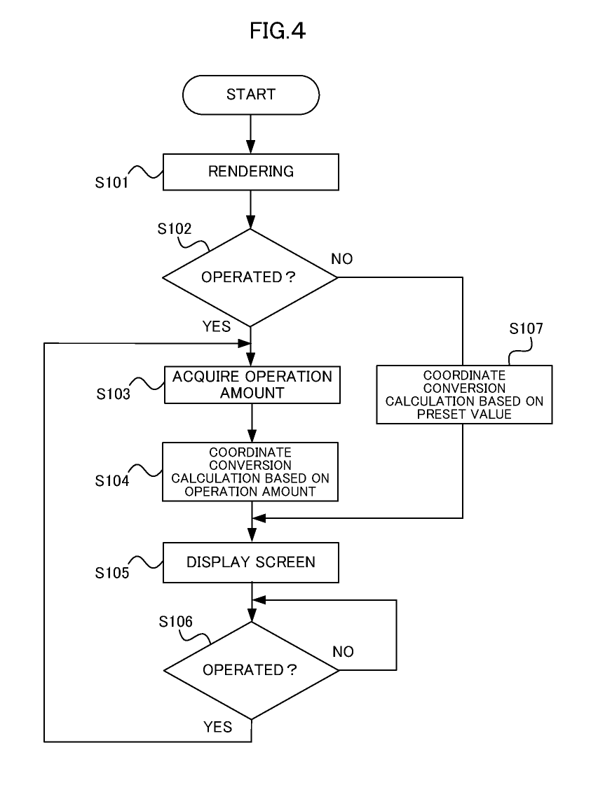

The following describes the overall operation of the present embodiment. FIG. 4 is a flowchart illustrating the operation of the cellular phone according to the present embodiment. Incidentally, according to the present embodiment, suppose the communication section 101 has already received Web page data and that the browser 112 has already acquired the Web page data from the TCP/IP stack through the memory.

First the browser 112 performs rendering of the Web page data to produce bitmap data and stores the bitmap data in the memory 102 (S101). The display control section 108 makes a determination as to whether the key of the operation section 106 is operated (S102).

When the key of the operation section 106 is operated (S102, YES), the coordinate conversion section 107 and the display control section 108 each acquire a key operation amount, which is information about how much the key is operated, from the operation section 106 (S103). The coordinate conversion section 107 and the display control section 108 perform a bitmap data coordinate conversion process on the basis of the operation amount as described below (S104). The OS 110 makes the graphic controller 104 display the bitmap data stored in the memory 102 on the LCD 105 via the VRAM 103 after the coordinate conversion process (S105). The display control section 108 makes a determination again as to whether the key of the operation section 106 is operated (S106).

When the key of the operation section 106 is operated (S106, YES), the coordinate conversion section 107 and the display control section 108 each acquire a key operation amount from the operation section 106 (S103).

When it is determined at step S106 that the key of the operation section 106 is not operated (S106, NO), the display control section 108 monitors the operation section 106 and makes a determination again as to whether the key of the operation section 106 is operated (S106).

When it is determined at step S102 that the key of the operation section 106 is not operated (S102, NO), the coordinate conversion section 107 and the display control section 108 perform a bitmap data coordinate conversion process on the basis of a preset value as described below (S107). The OS 110 makes the graphic controller 104 display the bitmap data stored in the memory 102 on the LCD 105 via the VRAM 103 after the coordinate conversion process (S105).

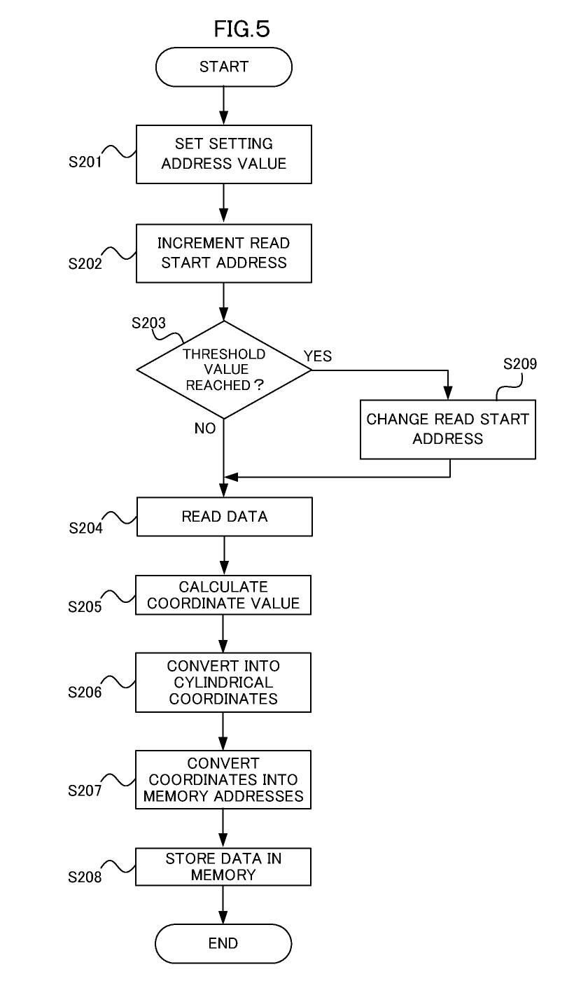

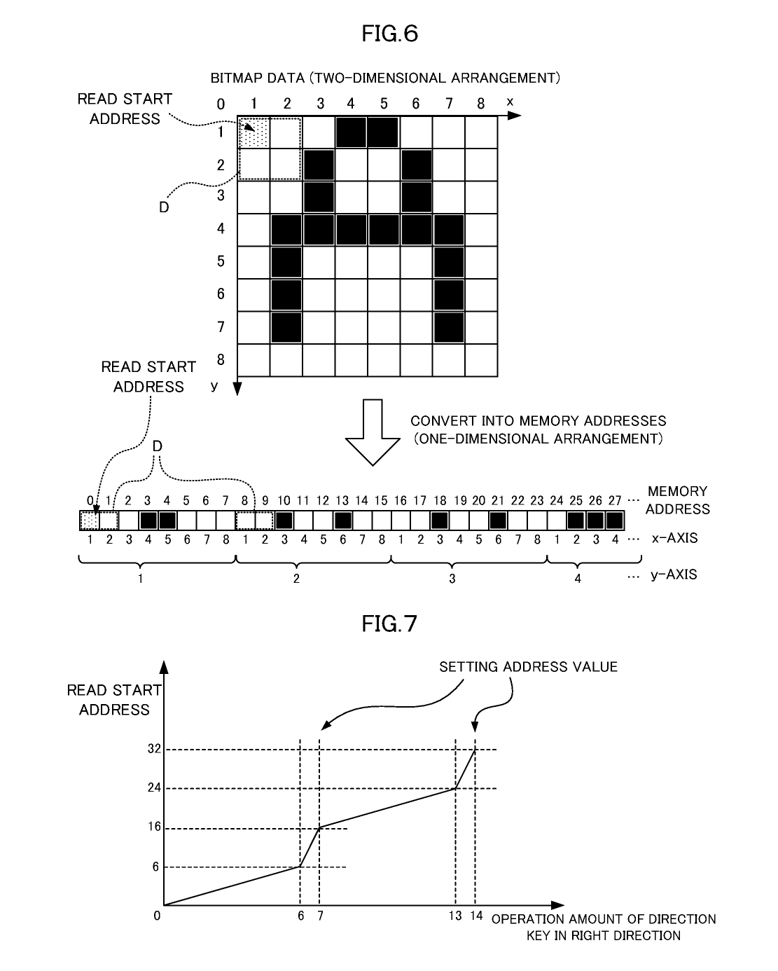

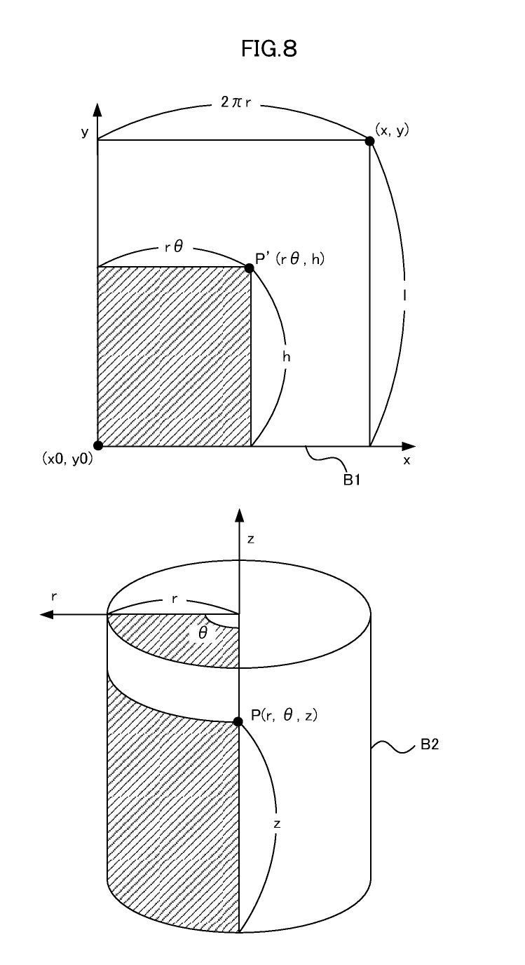

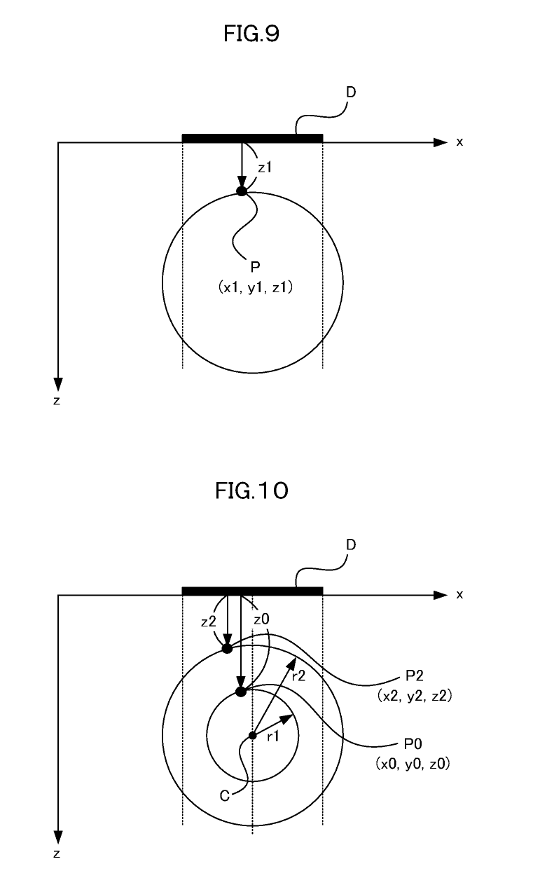

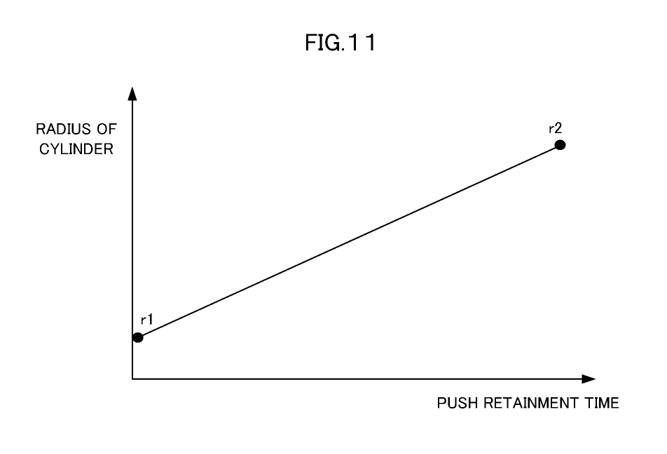

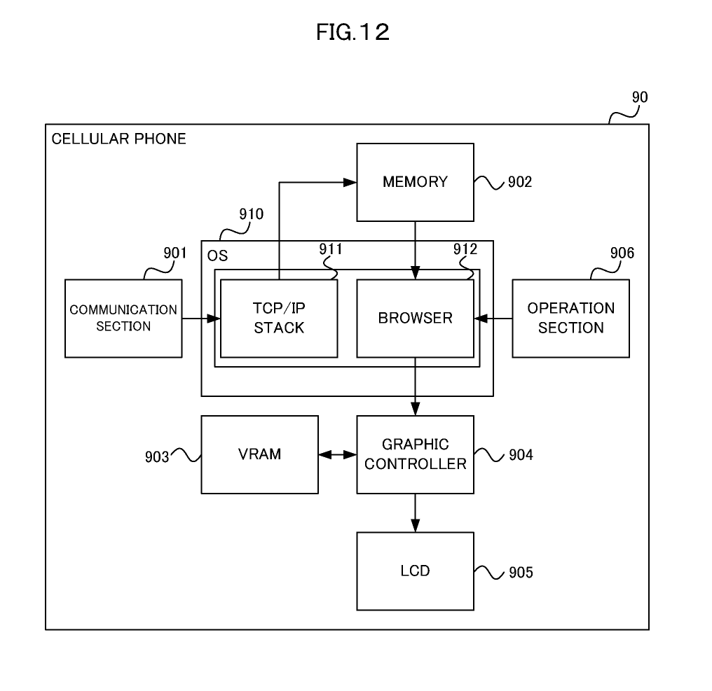

The following provides a description of a coordinate conversion calculation process that is based on the key operation amount with reference to FIG. 5 as well as FIGS. 6 to 11. FIG. 5 is a flowchart illustrating the operation of the bitmap data coordinate conversion process that is based on the key operation amount. FIG. 6 is a diagram illustrating the bitmap data stored in the memory. FIG. 7 is a graph illustrating a correlation between the operation amount of the direction key and the read start address. FIG. 8 is a diagram illustrating a relationship between a given pixel point on the bitmap data and a given pixel point whose coordinates have been converted. FIG. 9 is a diagram illustrating the distance between the display area on the screen and the cylinder. FIG. 10 is a diagram illustrating the cylinder and a radius thereof. FIGS. 9 and 10 illustrate the cylinder and the display area D seen from above with the coordinates of point P expressed in Cartesian coordinate system. FIG. 11 is a graph illustrating a correlation between the radius of the cylinder and a key push retainment time indicating how long the key is kept pushed. Incidentally, in FIGS. 5 to 11, for reasons of explanation, the display area D for display data is 2 pixels in height and 2 pixels in width. Moreover, FIG. 5 illustrates the process of step S105 of FIG. 4. Suppose that before the process of FIG. 5 starts, the key operation amount is already acquired. Furthermore, the key operation amount in FIG. 5 indicates how much a right key of the direction key 106a is pressed, unless otherwise stated.

First the display control section 108 sets a setting address value based on the width of the bitmap data (S201) and increments the read start address of the bitmap data stored in the memory 102 on the basis of the key operation amount (S202).

Described here are FIGS. 6 and 7. FIG. 6 is a diagram illustrating the bitmap data stored in the memory 102. The upper portion of FIG. 6 depicts the 8×8 bitmap data arranged in two-dimensional way. The display area of the bitmap data on the screen is indicated by D in the diagram. The left upper side of the diagram is a read start address for the bitmap data. In the example illustrated in the upper portion of FIG. 6, the read start address is (1, 1). The lower portion of FIG. 6 depicts the bitmap data converted into a one-dimensional arrangement. Incidentally, in the lower portion of FIG. 6, values of the bitmap data on x- and y-axes are associated with memory address. FIG. 7 is a graph in which the vertical axis represents the read start address and the horizontal axis the operation amount of the direction key in the right direction. Incidentally, in FIG. 7, a setting address value of (7, 14) is a value of the read start address at the time when the display area D in FIG. 6 reaches the right end of the screen.

A determination is made as to whether the incremented read start address becomes equal to the setting address value like the one illustrated in FIG. 7 (S203). In FIG. 7, the vertical axis represents the read start address and the horizontal axis the operation amount of the direction key 106a in the right direction. Incidentally, the operation amount of the direction key 106a corresponds to the pixels of the bitmap data. In FIG. 7, the setting address value of 7 means that the read start address has reached pixel position (7, 1) of the two-dimensional arrangement illustrated in FIG. 6. Incidentally, according to the present embodiment, the setting address value is so set in advance as to allow the right end of the display area D to reach the right end of the bitmap data. Instead, the setting address value may be set by a user.

When it is determined at step S203 that the read start address is equal to the setting address value (S203, YES), the display control section 108 changes the read start address and then transmits the read start address to the coordinate conversion section 107 (S209). According to the present embodiment, as illustrated in FIG. 7, when the operation amount reaches 7, the read start address, which has so far increased by 1 each time the operation amount has risen by 1, is changed to 16. Moreover, as illustrated in FIG. 6, the read start address of 16 corresponds to coordinates (1, 3) on the pixels of the bitmap data.

The coordinate conversion section 107 then reads from the memory 102 the data inside the display area D that is based on the read start address (S204), calculates the coordinates of the bitmap data from the memory address (S205), and converts the plane coordinates into cylindrical coordinates on the basis of a radius specified by the operation amount as described below (S206). As for the conversion of plane coordinates into cylindrical coordinates, as illustrated in FIG. 8, if the vertical axis of the plane indicated by B1 is represented by y, the horizontal axis by x, the coordinates of the upper right end of the plane B1 by (x, y), the coordinates of a given pixel point P′ by (rθ, h), the origin of the plane B1 by (x0, y0), the coordinates of a point P′ on the plane whose coordinates to be converted by (rθ, h), the length of the x-side of the plane B1 by 2πr, the length of the y-side by 1, the height of a cylinder B2 by z, the radius by r, and the angle at the center of a sector connecting the center of the circular portion of the cylinder B2 to both ends of the attached plane B1 on the horizontal axis by θ, the cylindrical coordinates (r, θ, z) of the point P, or converted point P′, are given by the following equations.

r=(x0, distance between×points)/2π(=2πr/2π)

θ=(=2π(rθ/2πr))

z=h

The coordinate conversion section 107 writes out the bitmap data that is at the converted coordinates, converts the pixels to be displayed on the LCD as illustrated in FIG. 6 into memory addresses (S207), and stores the memory addresses in the memory 102 (S208).

When it is determined at step S203 that the read start address is not equal to the setting address value (S203, NO), the coordinate conversion section 107 reads from the memory 102 the data inside the display area D that is based on the read start address (S204).

As described above, since the plane coordinates are converted into the cylindrical coordinates, a point becomes closer to the display area D as the point gets closer to the center of the cylinder as illustrated in FIG. 9. As a result, a display object put on the cylinder is more enlarged in the horizontal direction as the display object is displayed closer to the center of the display area D; the display object is more reduced in size in the horizontal direction as the display object is displayed closer to the ends of the display area D. The radius r of the circular portion of the cylinder B2 illustrated in FIG. 8 varies from a predetermined minimum radius of r1 to a maximum radius of r2 as illustrated in FIG. 10. For example, as illustrated in FIG. 11, the radius of the circular portion of the cylinder B2 changes according to how long the center of the direction key 106a of the operation section 106 is pressed. Based on the changed radius r, the coordinate conversion is carried out. Accordingly, the enlarged image of the mapped bitmap data B1 is displayed on the display area D. The radius r may decrease in size when the center of the direction key 106a and another button of the operation section 106 are pressed at the same time.

The conversion takes place on every pixel of the bitmap data B1. As for the x-axis coordinates, as illustrated in FIG. 6, the distance from the display area D to a given pixel point P on the cylinder B2 in the z-axis direction is regarded as the z-coordinates of each pixel mapped on the cylinder B2. Moreover, suppose that the center point of the display area D on the x-axis is equal to the value of the center of the circular portion of the cylinder B2 on the x-axis.

Moreover, in the coordinate conversion process at step S107 illustrated in FIG. 4 that is based on the preset value, the processes of steps S204 to S208 are performed based on a predetermined read start address and a predetermined radius r of a cylinder instead of the operation amount of the operation section 106.

Thanks to the above operation, it is possible to map the bitmap data B1 onto the cylinder B2. Since the bitmap data B1 is mapped onto the cylinder B2, the bitmap data B1 is more enlarged as the bitmap data B1 is displayed closer to the center point of the display area D on the x-axis. The bitmap data B1 is more reduced in size as the bitmap data B1 is displayed farther away from the center point of the display area D on the x-axis. Therefore, it is possible to improve the Web browsing capability of the LCD 105 having the small display area. Moreover, the setting address value is set on the bitmap data B1 mapped onto the cylinder B2 and the address data is changed when the setting address value is reached. Therefore, for example, when a text is read by a user, the user does not have to perform complicated operations because after reaching the right end, the display area returns to the left end and moves a predetermined distance in the vertical direction.

The present embodiment expects the following situation: the display of a cellular phone and a browser are used to view Web pages that are designed to be viewed on a personal computer. However, the display object is not limited to Web pages and may be image files of large sizes. Moreover, the display object may be displayed not only by the browser but also by other drawing software. The present invention allows a user to use the display of a relatively small size to view the display object of a size larger than the display without complicated operations. According to the present embodiment, the bitmap data of the display object is mapped on the surface of the cylinder. However, the object on which the bitmap data is mapped may be a polyhedron that is close in shape to the cylinder, or a sphere. If the device that displays the display objects has a less powerful processing capability, the device may not perform mapping.

Furthermore, a program for causing a computer of the display control device to execute the above steps may be provided as a display control program. The above program may be stored in a computer-readable recording medium, thereby enabling a computer of a design support device to execute the program. The above computer-readable recording media include an internal storage device such as ROM or RAM that is installed in a computer; a portable storage medium such as CD-ROM, flexible disks, DVD discs, magneto optical discs and IC cards; a database that retains computer programs; another computer and a database thereof; and a transmission medium on a line.

As described above, according to the present invention, it is possible to view display data without complicated operations.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A display control device comprising:
a memory that stores display data to be displayed on a display section;
an operation section that specifies a display area of the display section where the display data is displayed;
an address setting section that sets a setting address value with respect to a memory address of the display data stored in the memory;
an address specifying section that specifies a read start address value of the display area with respect to the memory address based on a first operation amount of the operation section; and
a specified address changing section that changes, when the read start address value is equal to the setting address value, the read start address value to a different address value, wherein
the display area of the display data is displayed in an orthogonal coordinate system and the setting address value corresponds to a predetermined coordinate value on one axis in the display area of the display data.

2. The display control device according to claim 1, wherein
the specified address changing section changes the read start address value to an address value corresponding to a different coordinate value on a different axis from the one on which there is at least the coordinate value corresponding to the setting address value.

3. The display control device according to claim 1, further comprising
a coordinate system conversion section that makes the display area of the display data change from the orthogonal coordinate system to a different coordinate system.

4. The display control device according to claim 3, wherein
the coordinate system conversion section maps the display area of the display data that is based on the specified read start address onto the side face of a cylinder.

5. The display control device according to claim 4, wherein
the radius of a circular portion of the cylinder varies according to a second operation amount of the operation section.

6. The display control device according to claim 1, wherein
the display data is HTML data that is rendered.

7. A computer-readable recording medium on which a display control program for controlling displaying of display data to be displayed on a display section is recorded, the computer-readable recording medium causing a computer to execute a process comprising:
setting a setting address value with respect to a memory address of the display data stored in a memory;
specifying, based on a first operation amount of an operation section that specifies a display area of the display section where the display data is displayed, a read start address value of the display area with respect to the memory address; and
changing, when the read start address value is equal to the setting address value, the read start address value to a different address value, wherein
the display area of the display data is displayed in an orthogonal coordinate system and the setting address value corresponds to a predetermined coordinate value on one axis in the display area of the display data.

8. The computer-readable recording medium according to claim 7, wherein
the changing of the read start address value changes the read start address value to an address value corresponding to a different coordinate value on a different axis from the one on which there is at least the coordinate value corresponding to the setting address value.

9. The computer-readable recording medium according to claim 7, further causing the computer to execute
making the display area of the display data change from the orthogonal coordinate system to a different coordinate system.

10. The computer-readable recording medium according to claim 9, wherein
the changing maps the display area of the display data that is based on the specified read start address onto the side face of a cylinder.

11. The computer-readable recording medium according to claim 10, wherein
the radius of a circular portion of the cylinder varies according to a second operation amount of the operation section.

12. A display control method for controlling displaying of display data to be displayed on a display section, the display control method causing a computer to execute:
setting a setting address value with respect to a memory address of the display data stored in a memory;
specifying, based on a first operation amount of an operation section that specifies a display area of the display section where the display data is displayed, a read start address value of the display area with respect to the memory address; and
changing, when the read start address value is equal to the setting address value, the read start address value to a different address value, wherein
the display area of the display data is displayed in an orthogonal coordinate system and the setting address value corresponds to a predetermined coordinate value on one axis in the display area of the display data.

13. The display control method according to claim 12, wherein
the changing of the read start address value changes the read start address value to an address value corresponding to a different coordinate value on a different axis from the one on which there is at least the coordinate value corresponding to the setting address value.

14. The display control method according to claim 12, further causing the computer to execute
making the display area of the display data change from the orthogonal coordinate system to a different coordinate system.

15. The display control method according to claim 14, wherein
the changing maps the display area of the display data that is based on the specified read start address onto the side face of a cylinder.
